(19) United States
(12) Patent Application Publication
(10) Pub. No.: US 2004/0041285 A1
(43) Pub. Date: Mar. 4, 2004

(54) Multi-component flow regulator wicks and methods of making multi-component flow regulator wicks

(76) Inventors: Jian Xiang, Midlothian, VA (US); Bennett Ward, Midlothian, VA (US); Curtis Fallecker, Hopewell, VA (US); Ulises Sanroma, Richmond, VA (US); Raymond Nelson, Powhatan, VA (US); Thomas Harris, Hopewell, VA (US); Jeffrey Green, Midlothian, VA (US)

Correspondence Address: MYERS BIGEL SIBLEY & SAJOVEC, PO BOX 37428, RALEIGH, NC, 27627, US

(21) Appl. No.: 10/465,286

(22) Filed: Jun. 19, 2003

Related U.S. Application Data
(60) Provisional application No. 60/389,936, filed on Jun. 20, 2002.

(51) Int. Cl. B01F 3/04

(52) U.S. Cl. 261/99; 261/104; 261/107

(57) ABSTRACT

A wicking device includes a core material and a polymeric shell material wherein the core material includes bonded fibrous materials providing a tortuous path for a gas and/or liquid, the core material being permeable to the gas and/or liquid and the shell material being impermeable to the gas and/or liquid.

### CROSS-REFERENCE TO RELATED APPLICATIONS

This application claims the benefit of, and incorporates herein by reference in its entirety, the following United States Provisional Application: U.S. Provisional Application No. 60/389,936, filed Jun. 20, 2002.

### FIELD OF THE INVENTION

This invention relates to the production and use of liquid and/or gas flow regulators. In particular, the invention relates to regulator elements that may be used to regulate the flow of a liquid or a gas.

### BACKGROUND OF THE INVENTION

The use of processes, systems, and devices for regulating the flow of gases and fluids is common in our society. Typically, the flow of gases and liquids can be regulated using valves to restrict or increase the amount of gas and/or liquid allowed to pass through the valve. In other instances, pressure differentials may be altered to regulate the flow of a gas or fluid in a system. In some cases, however, the use of valves and/or pressure differentials alone is insufficient to control the flow of gases and/or fluids.

For example, disposable gas lighters employ a valve system to regulate the flow of a hydrocarbon gas and/or liquid mixture to a flame generating point of the lighter. Although adjustable valves can be used with such lighters, they are not used with low-cost lighter systems in order to minimize costs. Instead, disposable lighters often rely upon a microporous polypropylene film in the valve assembly to control the flow of a gas and/or fluid mixture to the lighter flame. The microporous polypropylene film regulates the gas flow to the flame of the lighter and prevents liquid from entering the flame, which would cause unacceptably high flame height. However, the use of microporous polypropylene film as a gas flow regulator can be disadvantageous. For instance, the microporous polypropylene films for use in lighter valves must be cut from large sheet of film. Handling the tiny pieces of microporous polypropylene film cut from the larger sheets is difficult. Further, the processes for inserting the microporous polypropylene film into the lighter valve assemblies is labor intensive and expensive. A large amount of waste is also generated from the process. In addition, the number and size of openings in a microporous polypropylene film can result in variations in the flow control, which results in inconsistent flow regulation.

It is therefore desirable to provide a simple and inexpensive system for regulating the flow of gas and/or liquids. It is also desirable to provide a gas and/or liquid flow regulator for use with lighter systems.

### SUMMARY OF THE INVENTION

The present invention relates to wicking devices for regulating or controlling the flow of gas and/or fluid. The wicking devices of the present invention may be used with systems requiring the control or regulation of gas and/or fluid flow.

In various embodiments of the present invention a wicking device is provided wherein the wicking device includes a core material and a shell material. The core material of the wicking device may be constructed of bi-component or multi-component fibrous materials or polymers that are bonded or otherwise combined to provide a tortuous path through the core material. The core material is permeable to gas and/or liquid. The core material is surrounded in part by a shell material that is substantially impermeable to the gas and/or liquid. Gas and/or liquid may be transported through the core material of the wicking device at a constant, or substantially constant, flow rate. The core material is preferably chemically resistant to and/or inert with respect to the gas and/or liquid transported through the core material.

In various embodiments of the present invention, the core material is constructed from multi-component fibers that are drawn, spun, woven, twisted, crimped, entangled, bonded, or otherwise combined to form a substantially rigid core material. In some embodiments, the multi-component fibers include a core polymer surrounded by a sheath polymer. In other embodiments, the multi-component fibers may include varying mixtures of polymeric materials or fibers composed of two or more polymeric materials. Heat bonding or chemical bonding may bond the bi-component fibers within the core material. The core material may also be constructed of other types of multi-component fibers. For instance, melt blown fibers having low shrinkage and high strength can be made from low cost materials such as thermoplastic polymers. Such fibers preferably exhibit similar melting viscosity. It may also be desirous to create fibers having varying cross-sections, such as “H” or “X” or “Y” shapes. Other non-round cross-section shaped fiber materials may also be used. Furthermore, the multi-component fibers may include a mixture of different types of fibers having different properties, densities, sizes, lengths and shapes. Particular melting components and filtering components may be added to the multi-component fibers to provide additional qualities to the core material, such as the ability to filter particles from a gas or liquid.

In other embodiments of the present invention the core material includes a polymeric structure with sufficient porosity to provide a tortuous path through the core material such that gas and/or liquid may be wicked or otherwise communicated through the core material.

The shell material according to embodiments of the present invention covers or surrounds at least a portion of the core material and acts as an impermeable layer between the core material and gas and/or liquid in which the wicking device may be used. The shell material is preferably chemically resistant to and/or inert with respect to the gas and/or liquid transported through the core material. The shell material and core material are preferably bonded together, e.g. sealed, in a way to avoid the formation of voids or spaces between the shell material and core material. In some embodiments of the present invention the shell material is constructed of a polymeric material that is extruded onto the core material or wrapped around the core material and sealed. In other embodiments of the invention, a core material may be treated, such as with heat or chemicals, to alter the outer surface of the core material to form an impermeable shell material.

Other embodiments of the present invention include processes and methods for constructing wicking devices according to embodiments of the present invention. The processes and methods include both continuous and non-continuous process. For instance, a core material may be formed and a shell material bonded with the core material in a continuous process to form a wicking device. Alternatively, the wicking device may be formed in a non-continuous process where a core material is formed and collected before being fed to a second process where a shell material is bonded with the core material.

In a non-continuous process for making a wicking device according to the present invention a core material is a bonded fiber element that is constructed from fibers supplied to the process wherein the fibers are entangled, heated, and formed into a bonded fiber element having a desired shape. Heat applied to the fibers to form the bonded fiber element may be supplied by steam, hot air, or other energy sources. The bonded fiber element is then collected for further processing, such as by rolling a continuous length of bonded fiber element on a spool.

The collected bonded fiber element is then adhered to a shell material using a second process. For instance, the collected bonded fiber element may be fed to an extruder die wherein a molten polymeric material is applied to the bonded fiber element and cooled to form a shell material. The shell-covered bonded fiber element may be cut into desired sizes to produce wicking devices. In other embodiments, the bonded fiber element may be wrapped with a polymeric material and the polymeric material sealed to form a shell material over the core material. In still other embodiments, a surface of the bonded fiber element may be treated to melt or otherwise alter the surface of the bonded fiber element to produce a shell material from the surface of the bonded fiber element.

In other embodiments of the present invention the wicking devices are constructed in a continuous process. A core material, such as a bonded fiber element, may be formed from fibers that are collected, heated, and formed into a desired bonded fiber element shape. The formed bonded fiber element is then fed directly to an extruder die wherein molten polymeric material is applied to the bonded fiber element and cooled to form a shell material over the bonded fiber element. Heating the surface of the bonded fiber element prior to feeding the bonded fiber element to the extruder die may improve the bonding between the bonded fiber element and the shell material. In other embodiments, the bonded fiber element may be wrapped with a polymeric material and sealed to form the shell material. In still other embodiments, the bonded fiber element may be treated to melt or otherwise alter the surface of the bonded fiber element to produce a shell material from the surface of the bonded fiber element.

### BRIEF DESCRIPTION OF THE DRAWING FIGURES

The invention can be more readily ascertained from the following description of the invention when read in conjunction with the accompanying drawings in which:

FIG. 1 illustrates a device for regulating gas and/or liquid flow according to various embodiments of the present invention;

FIG. 2 illustrates a photograph of a cross-sectional view of a wicking device according to various embodiments of the present invention;

FIG. 3 illustrates a cross-sectional view of a wicking device according to various embodiments of the present invention;

FIG. 4 illustrates a wicking device used to regulate the flow of a liquid from a reservoir according to embodiments of the present invention;

FIG. 5 illustrates a general process flow diagram for various embodiments of the present invention;

FIG. 6 illustrates a process for forming core materials according to various embodiments of the present invention;

FIG. 7 illustrates a process for forming a shell material over a core material according to various embodiments of the present invention; and

FIG. 8 illustrates a continuous process for making wicking devices according to embodiments of the present invention.

### DETAILED DESCRIPTION OF THE INVENTION

The present invention is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, the thickness of layers and regions are exaggerated for clarity. Like numbers refer to like elements throughout.

Various embodiments of the present invention relate to multi-component wicks and wicking devices. Although the terms “wick” and “wicking device” are used herein to describe various embodiments of the present invention, it is understood that the use of the terms also includes transport elements or regulator elements that facilitate or regulate the flow of gas and/or fluid in devices of various embodiments of the present invention. The use of the terms “wick” and “wicking device” is not meant to limit the embodiments of the invention to devices that act exclusively or in part through the wicking of gas and/or fluid in the devices. The use of the term “bi-component” is not meant to limit the embodiments of the invention to a particular number of components; rather, it is understood that “bi-component” materials may also be “multi-component” materials having two or more materials. Still other embodiments of the invention relate to methods for making multi-component wicks and wicking devices.

In various embodiments of the present invention a wicking device includes a length of core material with two ends wherein at least a portion of the length of core material is encapsulated or covered by a shell material. The core material includes spaces or voids within itself, which spaces or voids provide a tortuous path for the passage of a gas and/or a liquid through the core material of the wicking device. The tortuous path through the core material and the porosity of the core material help to regulate the flow of a gas and/or liquid through the wicking device such that wicking devices of similar sizes and shapes maintain a consistent flow rate of the gas and/or liquid through the wicking device. Preferably, the core material is chemically resistant to and/or inert with respect to the gas and/or liquid used with the wicking device and is permeable to the gas and/or liquid. Furthermore, the shell material covering the core material is also chemically resistant to and/or inert with respect to the gas and/or liquid used with the wicking device such that it preferably does not break down or decompose in the gas and/or liquid. The shell material is also preferably impermeable to the gas and/or liquid.

In some preferred embodiments, the core material is a bonded fiber element that includes fibrous materials that are drawn, spun, woven, twisted, crimped, entangled, bonded or otherwise combined to form the bonded fiber element. The fibrous materials include one or more core polymers, which may also be surrounded by a sheath polymer. The fibrous materials may be bonded together to form the bonded fiber element. For instance, sheath polymers surrounding core polymers of fibrous materials may be heated to cause the sheath polymers to soften, allowing them to spot bond together, thereby forming a porous, bonded fiber element of sheath polymer coated core polymers.

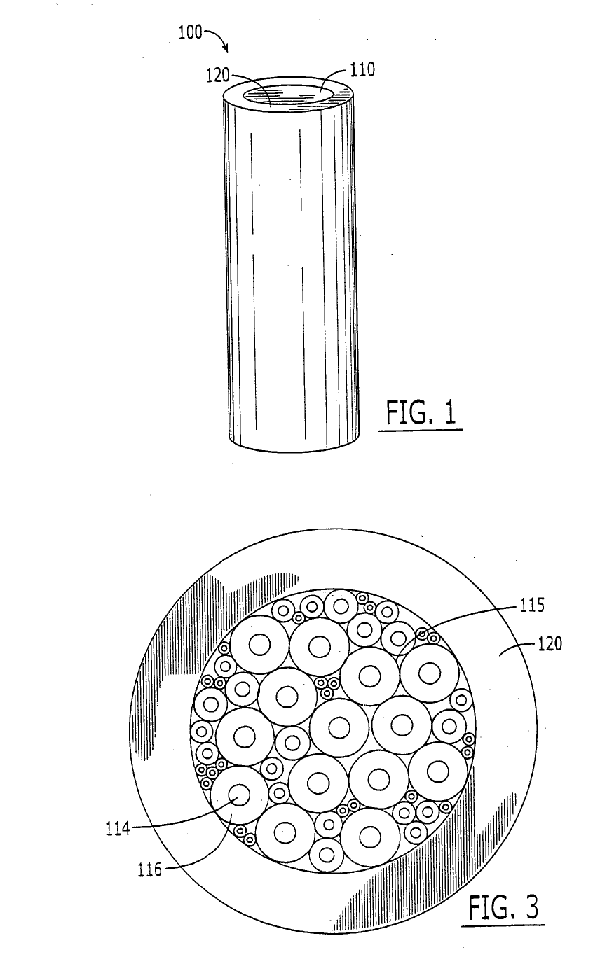

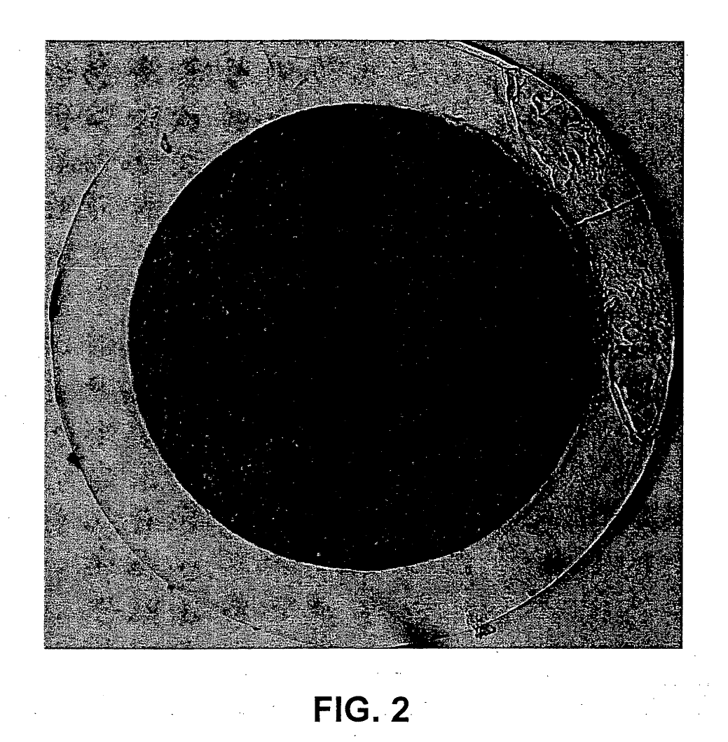

A multi-component wicking device 100 according to certain embodiments of the present invention is illustrated in FIG. 1. The illustrated wicking device 100 includes a core material 110 surrounded by a shell material 120. A cross-section of the core material 110 and shell material 120 is illustrated at an end of the wicking device 100 and a photograph of a cross-section of a wicking device 100 according to various embodiments of the present invention is illustrated in FIG. 2. In some embodiments the wicking device 100 may also include one or more coatings (not shown) over the shell material 120. Although the illustrated multi-component wicking device 100 has a cylindrical shape, it is understood that the wicking device 100 may include various shapes and sizes.

The core material 110 of the wicking device 100 may preferably include one or more fibrous materials that are drawn, spun, woven, twisted, crimped, entangled, bonded, or otherwise combined to form a porous, bonded fiber element that is permeable to liquids and/or gases. FIG. 3 illustrates a cross-section of a wicking device 100 having a bonded fibrous element core material 110 according to embodiments of the invention. The porous, bonded fiber element includes fibrous materials having core polymers 114 and sheath polymers 116. The sheath polymers 116 are preferably bonded together to form the porous, bonded fiber element. The bonding of the fibrous materials forms spaces or voids 115 within the porous, bonded fiber element. The core polymer 114 and the sheath polymer 116 may be derived or made from the same or different polymers. Although the illustrated porous, bonded fiber element includes multiple fibrous materials it is understood that the number of fibrous materials in the porous, bonded fiber element may vary and may be dependent upon the selected application of the wicking device 100. The number and type of fibrous materials used to construct the porous, bonded fiber element may also depend upon the desired porosity and density of the core material 110 for the wicking device.

Construction of porous, bonded fiber elements is not limited to sheath polymer 116 coated core polymers 114. Other bi-component and/or multi-component fibrous materials may be used to form the porous, bonded fiber element. For instance, melt blown fibers having low shrinkage and high strength can be made from low cost materials. Such fibers preferably exhibit similar melting viscosity. It may also be desirous to create fibers having varying cross-sections, such as “H” or “X” or “Y” shapes. Other non-round cross-section shaped fiber materials may also be used. Furthermore, the multi-component fibers may include a mixture of different types of fibers having different properties, densities, sizes, lengths and shapes. Particular melting components and filtering components may be added to the multi-component fibers to provide additional qualities to the core material, such as the ability to filter particles from a gas or liquid.

In some embodiments of the present invention, the core material 110, such as a porous, bonded fiber element, may be more permeable to liquid than to gas. In other embodiments, the core material 110 may be more permeable to gas than to liquid. In still other embodiments, the core material 110 may be equally permeable to gas and to liquid. The permeable nature of the core material 110 can be regulated in part by the selection of the fibrous materials used to construct the core material 110. The permeable nature of the core material 110 may also be regulated by the manufacture of the core material 110, for example, by varying the density, types, and/or amount of fibrous materials used in construction of the core material 110.

Different fibrous materials may impart different qualities to the core material 110, which qualities tend to regulate the flow of gas, liquid, or gas and liquid through the core material 110. The selection of a bi-component fiber for use in constructing a core material 110 depends upon the intended use of the core material 110. For instance, if the fiber density and diameters of the two core materials 110 are the same, two core materials 110 made from different bi-component fibers may perform differently. Fibrous materials that may be used to construct a core material 110 according to embodiments of the present invention may include, but are not limited to bi-component and multi-component fibers of polyolefins, such as polyethylene, polypropylene, and copolymers thereof, polyseters, such as polyethylene terrephthalate, polyethylene terephthalate copolymers and polybutylene terephthalate and copolymers thereof, polyamides, such as nylon 6 and nylon 66 and copolymers thereof, flouropolymers, polyarylates, polycarbonates, polyvinyl chloride, polystyrene, ABS, acetal homopolymers and copolymers, polyacrylonitrile, polymethylmethacrylate, polyvinyl alcohol, polyethyleneglycol, and ethylene vinyl alcohol copolymers.

Selection of the bi-component fibers used to construct a core material 110 depends upon the intended use of the wicking device 100. In certain embodiments, the core material 110 is resistant to the gas and/or liquid being wicked by the wicking device 100. Fibrous materials resistant to the gas and/or liquid that will be used with the wicking device 100 are selected to help ensure that the core material 110 will withstand the intended use of the wicking device 100. For example, wicking devices 100 used to wick hydrocarbon gases and/or liquids are constructed such that the core material 110 does not break down, dissolve, or swell in the hydrocarbons. For instance, fibrous materials including PET, polyesters, and polyamides may be selected. The core materials 110 are selected because of their resistance to or compatibility with the hydrocarbon gasses and/or liquids.

The construction of the core material 110 also regulates the flow of gas, liquid, or gas and liquid through the core material 110. The flow of gas and/or liquid through a core material 110 of a wicking device 100 depends upon the porosity of the core material 110. By altering the porosity of the core material 110, the flow of gas and/or liquid through the core material 110 may be changed and controlled. The porosity of the core material 110 may be altered in any number of ways, including, for example, by altering the density of core material 110, altering the degree of entanglement of fibrous materials in the core material 110, altering the denier values of fibers used in the core material 110, or any combination thereof. For instance, the porosity of core material 110 for a given diameter of core material 110 may be altered by increasing or decreasing the number of fibers used in the construction of the core material 110. Two core materials 110 having the same diameter perform differently if one of the core materials 110 includes more fibers within the core material 110, thereby providing a higher density of fibers in the core material 110.

According to some embodiments of the invention, a tortuous flow of gas and/or liquid occurs in the core material 110. The arrangement of fibers or polymer material within the core material 110 provides voids 115 between fibers and in particular between the sheath polymers 116 of the fibers as illustrated in FIG. 3. It is believed that the flow of gas and/or liquid through the core materials 110 of the present invention follows a tortuous path along the fibers within the voids 115 between the fibers.

Another consideration in the construction of a core material 110 is the denier value of the fibers used to form the core material 110. A “denier” value represents the weight per unit length of a fiber. For example, in various embodiments of the present invention for wicking hydrocarbon gas and/or liquid, the denier value is at or between about 2 denier per filament (dpf) to about 5 dpf within the core material 110. The denier value may also be between about 1 and about 10 within the core material 110. In still other embodiments, such as in non-hydrocarbon wicking devices 100, the denier value may be selected according to the expected use for the wicking device 100, such as between about 0.1 dpf and about 300 dpf.

The arrangement of fibers within the core material 110 may also alter the flow of gas and/or liquid through the core material 110. For instance, core materials 110 formed of crimped fibers may perform differently than core materials 110 made from non-crimped fibers. Core materials 110 according to various embodiments of the present invention include fibers that are drawn, spun, woven, twisted, crimped, entangled, bonded or otherwise combined to form a core material 110 having a desired diameter.

The shell material 120 of the wicking device 100 surrounds at least a longitudinal portion of the core material 110. The shell material 120 may cover the entire length of a core material 110 or only a portion of the core material 110. Various compounds may be wrapped around the core material 110 and sealed or extruded onto the core material 110 to form the shell material 120. In other embodiments of the invention a surface of the core material 110 may be treated or otherwise altered to melt or change the surface of the core material 110 into a non-permeable shell material 120. Preferably, the shell material 120 is bound to the core material 110 such that there are no gaps or open spaces between the shell material 120 and the core material 110. Chemical bonding, heat bonding, or other methods may be used to help ensure that such gaps do not exist between the core material 10 and shell material 120.

In some embodiments, the shell material 120 may be absent from two ends of the wicking device 100 exposing the core material 110 at the ends. In other embodiments, a shell material 120 covers the ends of the wicking device 100, protecting the core material 110. To use a wicking device 100 wherein the shell material 120 encompasses all of the core material 110, the ends of the wicking device 100 are trimmed to expose a cross-section of core material 110.

In various embodiments of the invention, the shell material 120 includes a polymer that is impermeable to the gas and/or fluid being used with the wicking device 100. In particular, polymeric materials may be used as the shell material 120. The impermeable nature of the shell material 120 prevents gas and/or liquid from penetrating the core material 110 through the shell material 120. Thus, the gas and/or liquid communicated by the wicking device 100 is drawn into the core material 110 at the ends of the wicking device 100 where the core material 110 is exposed, but not through the shell material 120. In other embodiments the shell material 120 may be permeable to the gas and/or liquid.

In some embodiments of the invention the shell material 120 is also resistant to or inert with respect to the gas and/or liquid used with the wicking device 100. When exposed to the gas and/or liquid used with the wicking device 100, the shell material 120 preferably exhibits minimal swelling or does not swell. Furthermore, the shell material 120 preferably does not chemically react with the gas and/or liquid used with the wicking device 100.

Various shell materials 120 may be selected for the various embodiments of the present invention. The shell materials 120 selected may include polymers such as polyolefins, such as polyethylene, polypropylene, and copolymers thereof, polyseters, such as polyethylene terrephthalate, polyethylene terephthalate copolymers and polybutylene terephthalate and copolymers thereof, polyamides, such as nylon 6 and nylon 66 and copolymers thereof, flouropolymers, polyarylates, polycarbonates, polyvinyl chloride, polystyrene, ABS, acetal homopolymers and copolymers, polyacrylonitrile, polymethylmethacrylate, polyvinyl alcohol, polyethyleneglycol, and ethylene vinyl alcohol copolymers.

In those instances where the core material 110 is a porous, bonded fiber element including core polymers 114 surrounded by sheath polymers 116 the ratio of sheath polymer 116 to core polymer 114 used with the various embodiments of the invention may vary. However, in some embodiments, the sheath polymers 116 constitutes about 30 percent by weight of the porous, bonded fiber element while the core polymers 114 constitutes about 70 percent by weight. Other ratios of sheath polymer 116 to core polymer 114 for porous, bonded fiber elements used as core materials 110 according to the embodiments of the present invention include 0 to 100, 30 to 70, 40 to 60, and 50 to 50 to 100 to 0, with 30 to 70 being preferred for hydrocarbon gas and/or liquid applications. Although these ratios may be preferred, it is understood that the sheath polymer 116 to core polymer 114 ratios in a porous, bonded fiber element may vary widely depending upon the intended application.

In some embodiments of the present invention the porous, bonded fiber element may be self crimpable.

Wicking devices 100 according to various embodiments of the present invention transport gas, fluid, or gas and fluid through the wicking device 100. Gas and/or fluid enters the wicking device 100 at one end of the wicking device 100 where a cross-section of core material 110 is exposed to the gas and/or fluid. In various embodiments, gas and/or fluid enters the core material 110 and follows a tortuous path through the core material 110 to a second end of the wicking device 100.

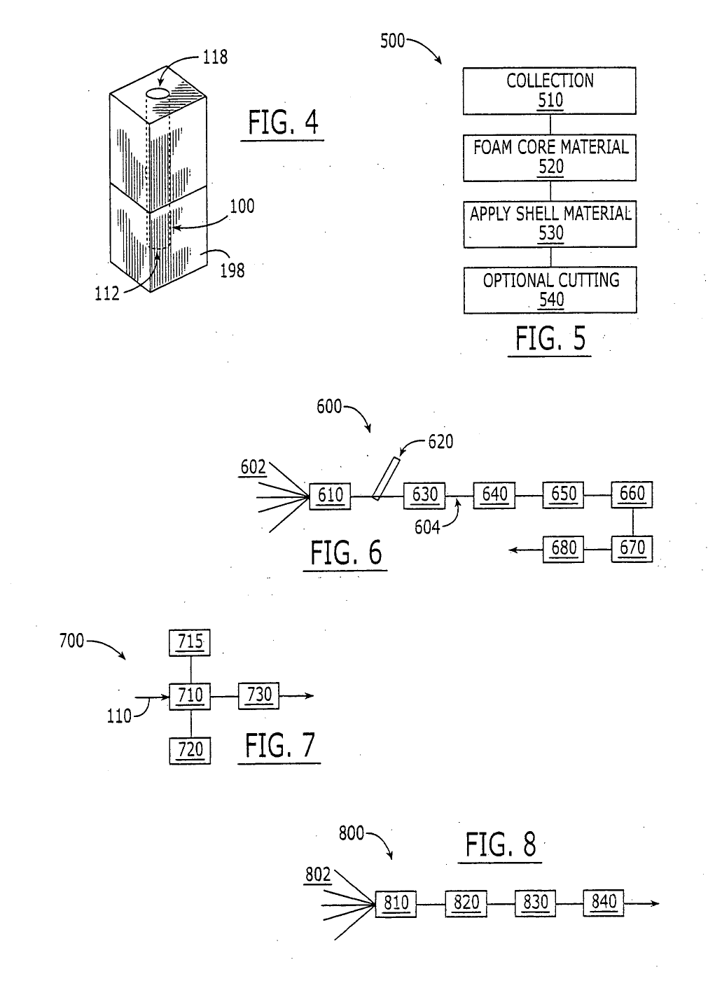

For example, a wicking device 100 according to embodiments of the present invention may be placed in a reservoir holding a liquid as illustrated in FIG. 4. A first end 112 of the wicking device 100 includes a cross-sectional exposure of the core material 110. The first end 112 is contacted with a liquid 198, such as butane. A second end 118 of the wicking device 100 is not in contact with the liquid 198. The liquid 198 in the reservoir may be under pressure which allows gas and/or liquid to enter the core material 110 at the first end 112 and follow a tortuous path through the core material 110 to escape at the second end 118 of the wicking device 100. The core material 110 is constructed of a material that is resistant to or compatible with the liquid 198 and the gas phase of the liquid 198 so that the core material 110 does not disintegrate or otherwise breakdown during exposure to the liquid 198. Similarly, the shell material 120 surrounding the core material 110 is also resistant to or compatible with the liquid 198 so that the shell material 120 does not break down or otherwise decompose when exposed to the liquid 198. Furthermore, the shell material 120 is constructed of a material that is substantially impermeable to the liquid 198 and any gas with the liquid 198 so that the only place for gas and/or liquid to escape from the reservoir is into the first end 112 of the core material 110.

Wicking devices 100 such as that illustrated in FIG. 4 can be used to transport hydrocarbon gas and/or liquid and to regulate the flow of hydrocarbon gas and/or liquid through the wicking device 100. Using the wicking devices 100 of embodiments of the present invention the flow rates of liquids and gases through the wicking devices 100 are controlled. The characteristics of the core materials 110 and shell materials 120 may be altered to control such flow rates. In this manner, wicking devices 100 can be used to regulate flow rates based upon the construction of the wicking device 100.

Control of the flow rate of a gas and/or a liquid through a wicking device 100 according to embodiments of the invention may depend upon the size of wicking device 100, such as the diameter and length of the wicking device 100 or core material 110, the construction of the wicking device 100, and the choice of materials used as the core material 110 and shell material 120.

The size of the core material 110, including the diameter and length, regulates the amount of gas and/or liquid that may enter the wicking device 100 at any one time. The diameter may be increased or decreased in order to allow a greater or smaller amount of gas and/or liquid to enter the wicking device 100 through the core material 110. Limitation of gas and/or liquid entry also limits the rate of gas and/or liquid flow out of the wicking device 100. Thus, the wicking device 100 acts as a flow rate regulator.

The porosity of the core material 110 also regulates the rate at which a gas and/or liquid passes through the core material 110 and through the wicking device 100. The porosity of the core material 110 may be altered in many ways. For example, changing the density of the core material 110 may alter the porosity. For instance, additional bi-component fibers may be added to an established diameter of core material 110, thereby increasing the amount of bi-component fibers in the same cross-sectional area of the core material 110, thus increasing the density and lowering the porosity. Similarly, fewer bi-component fibers may be used to produce the core material 110, thereby decreasing the number of bi-component fibers in a cross-sectional area of the core material 110 and having the opposite effect on density and porosity. In other embodiments, the denier value of the bi-component fibers used to construct the core material 110 may be increased or decreased to change the density and therefore the porosity of the core material 110.

The flow rate of gas and/or liquid through the core material 110 can also depend on how the bi-component fibers are arranged or entangled in the core material 110.

The characteristics of the core materials 110 and shell materials 120 of the wicking devices 100 of the present invention can be controlled by the manufacturing processes used to make the wicking devices 100. A general flow diagram of a process that may be used to create wicking devices 100 of various embodiments of the invention is illustrated in FIG. 5. In the process 500, fibrous materials to be used as the core material 110 are collected in step 510. The collected fibrous materials are formed into the desired core material 110 in step 520. In step 530a shell material 120 is applied over the core material 110 or formed by altering the structure of the core material 110. Step 540 involves the optional cutting of the product from step 530 to form the wicking devices 100 of the present invention.

FIG. 6 illustrates a more detailed process 600 for making bonded fiber elements for the core material 110 of a wicking device 100 according to embodiments of the present invention. Fibers 602, such as bi-component or multi-comoponent fibrous materials, are supplied to a draw tube 610. The fibers 602 may be supplied from a creel (not shown) or other fiber source. After passing through the draw tube 610 the fibers 602 are crimped in a well known manner, such as by a relaxed tow method 620. The crimped fibers 602 are directed into a first air stuffer jet 630 where the fibers 602 are entangled to form a first entangled fiber mass 604. The entangled fiber mass 604 is subjected to heat in a hot air oven 640 and then fed to a second stuffer jet 650. The temperature within the hot air oven 640 is varied depending on the melting point of the fibers 602 being processed and the desired state of bonding required for the fibers 602. The entangled fiber mass 604 exiting the second stuffer jet 650 is pulled through a preform die 660 to compact the entangled fiber mass 604. The compacted entangled fiber mass 604 is then passed to a forming die 670 where it is sized and bonded to the desired core material 110 shape. The forming die 670 may be heated. The bonded fiber element, or core material 110, exiting the forming die 670 is cooled to maintain the desired shape of the core material 110. The core material 110 may be cooled by passing the formed core material 110 through one or more cooling dies 680 which are cooled by cold air flow. A cooling bath may also be used to cool the core material 110.

The core material 110 formed using process 600 may be collected on spools or in various lengths and then coated with a shell material 120 as shown in the process 700 illustrated in FIG. 6. The core material 110 is fed to an extruder die 710 where a polymeric coating or extruded wrap is applied to the core material 110. The extruder die 710 may include a polymer supply 715 for supplying polymeric material for extrusion to the extruder die 710. The extruder die 710 may also include a vacuum 720 for providing suction within the extruder die 710 to facilitate the adhesion of the shell material 120 to the core material 110. The extruder die 710 may also include a pre-heater for heating the core material 110 prior to the core material 110 entering the extruder die 710. Preheating the core material 110 may help bond the extruded wrap to the core material 110. The polymeric coating formed on the core material 110 in the extruder die 710 is hardened to form the shell material 120 of the wicking device 100. The polymeric coating may be hardened or cured by passing the polymeric material coated core material 110 through a cooling bath 730 to cool the polymeric material, resulting in the formation of the shell material 120. Alternatively, the polymeric coating may be cooled by a stream of cooling air. The shell material 120 coated core material 110 exiting the extruder die 710 or cooling bath 730 may be cut into desired wicking devices 100.

In other embodiments of the present invention a core material 110 may be wrapped with a polymeric material to form the shell material 120 around the core material 110. For instance, prior to cooling the core material 110 exiting the forming die 670 may be fed to a garniture with a plastic film overwrap supply. The overwrap may be wrapped around the core material 110 and sealed, for instance by an adhesive, chemical, physical or thermal bonding, using the garniture in order to form a shell material 120 over the core material 110.

In still other embodiments, a surface of the core material 110 may be modified to convert a portion of the surface of the core material 110 into a shell material 120. For instance, the surface of a bonded fiber element may be heated to a sufficient temperature to melt or alter the structure of the surface of the bonded fiber element thereby forming a shell material 120 from a portion of the bonded fiber element.

Although processes 600 and 700 are illustrated as a non-continuous process it is understood that processes 600 and 700 may be combined in a continuous process such that a bonded fiber element would proceed from the forming die 670 to an extruder die 710 in the same process.

In other processes according to the present invention, the formation of the core material 110 and the shell material 120 of a wicking device 100 are performed in a continuous process 800 as illustrated in FIG. 8. Fibers 802, such as bi-component and multi-component fibrous materials, are collected and fed to one or more steam dies 810 where the fibers 802 are contacted with steam. Following steam contact, the fibers 802 are fed to a hot air die 820. The contact of the fibers 802 with the steam and heat may cause a realignment or reorientation of the fibers 802. The fibers 802 are then gathered and shaped in a forming die 830 to form a core material 110, such as a bonded fiber element. A bonded fiber element exiting the forming die 830 may be fed directly to an extruder 840 where a polymeric shell material 120 is applied to the bonded fiber element. A pre-heater (not shown) may be used to heat the bonded fiber element before it enters the extruder 840 in order to promote adhesion with the polymeric shell material 120 applied by the extruder 840. The polymeric material-coated bonded fiber element exiting the extruder 840 may be cooled, such as in a cooling bath (not shown) to harden or cure the polymeric material, thereby completing the formation of the shell material 120.

The process illustrated in FIG. 8 may also be divided into a non-continuous process. For instance, the bonded fiber element may be collected without sending it directly to an extruder 840. The collected bonded fiber element could then be later coated with a shell material 120 in a second process. The shell material 120 may be formed from a polymeric material applied by an extruder, a polymer wrap that is adhered or otherwise sealed to the bonded fiber element, or by heating a surface of the bonded fiber element to convert at least a portion of the surface to a shell material 120.

Use of continuous processes rather than non-continuous processes to form wicking devices 100 of the present invention may speed up and simplify the production process of the wicking devices 100.

To eliminate gaps or leakage points between a core material 110 and a shell material 120, the temperature of a formed core material 110 may be increased prior to feeding the core material 110 to an extruder. Increasing the temperature of a portion of a surface of the core material 110 softens its surface and facilitates fusion of the molten polymer shell material 120 with the core material 110 during the extrusion process. The heating of the core polymer 110 before extrusion improves the seal between the core material 110 and the shell material 120 in the finished wicking devices 100 and may decrease the number of voids or spaces between the core material 110 and shell material 120. In some embodiments of the invention the bonds between a core material 110 and shell material 120 are preferably void free, which may be accomplished by the additional heating of the core polymer. Increasing the temperature of the surface of a core material 110 to facilitate bonding with a shell material 120 may be used with any wicking device 100 production process.

Another way to facilitate the adhesion of the shell material 120 to the core material 110 is to select the materials such that polymer compatibility is promoted. For instance, choosing materials for both the shell material 120 and core material 110 from the family of polyesters facilitates adhesion. Such adhesion may be reduced if polymers from dissimilar chemical families are chosen. In addition, adhesion may be promoted by the use of various additives, copolymers, co-extrusions, etc., which are well known to those skilled in the art, which promote adhesion or polymer compatibility between dissimilar polymer substances.

According to certain embodiments of the present invention, a wicking device 100 is attached to a valve in a lighter to regulate a flow of liquid or gas to the valve. Lighters commonly include a housing defining a liquid reservoir wherein a flammable gas and/or liquid may be stored. A valve in the lighter housing prevents gas and/or liquid from leaving the reservoir when closed and allows gas and/or liquid to escape when opened. When opened, the production of a spark at the valve opening may ignite any escaping gas and/or liquid, thereby producing a flame. It is desirable to control the height of the flame exiting a lighter. One end of a wicking device 100 according to embodiments of the present invention may be attached to the valve of a lighter and the other end of the wicking device contacted with a hydrocarbon gas and/or liquid stored in the lighter reservoir. The wicking device 100 controls or regulates the flow of gas and/or liquid to the lighter valve, thereby regulating the amount of gas and/or liquid passed through the valve to create a consistent flame. The regulation of the gas and/or liquid supply to the valve produces a reproducible flame height for the lighter, which may be desirable.

Numerous examples of wicking devices 100 according to embodiments of the present invention were made and tested to regulate the flow of gas and/or liquid to a valve. Wicks without shell materials 120 were originally tested but it was found that such wicks could not consistently regulate the flow of gas and/or liquid and that unpredictable flow rates resulted. Shell materials 120, in the form of extruded wraps, that were impermeable to the gases and/or liquids being used were then added to the core materials 110 to form wicking devices 100. These wicking devices 100 provided a tortuous path for the gas and/or liquid to travel along the core material 110 within the shell material 120. The results were wicking devices 100 that regulated the flow rate of gas and/or liquid through the wicking device 100. The results of some of the tests of these materials are illustrated in Table I. The tests were performed by assembling lighters and testing the flame height produced by the assembled lighters. Lighter blanks and valves assemblies were obtained. Wicking devices 100 were attached to the valve assemblies and sealed to the lighter blanks filled with a hydrocarbon gas and/or liquid. The valve and wicking devices 100 were sealed to the lighter blanks at a temperature of below 40° C. by inserting the valve/regulator assembly into the lighter blanks filled with gas and/or liquid using a small Arbor press. A cap was then placed on the valve, a spring inserted, and the gas valve inserted. The lighters were lit using an igniter to test the flame heights. Flow rates of the wicking devices 100 were measured by forcing air through the wicking devices 100 at 15 pounds per square inch and measuring the flow rate.

TABLE I

| | | | | |
|---|---|---|---|---|
| | | | | Chemical |
| | | | | Resistance to |
| | | | | Hydrocarbon |
| Fiber Type | Coating | Density | Flame | gas/fluid |

| | | | | |
|---|---|---|---|---|
| COPET/PET | None | 0.86 | Excessive | |
| COPET/PET | PP | 1.039 | Excessive | PP Swells |
| Hydrofill/PET | None | 1.05 | Excessive | |
| Hydrofill/PET | PP | 1.032 | Excessive | PP Swells |
| Hydrofill/PET | PET | N/A | N/A | PP flaked off rod |
| Hydrofill/PET | Nylon | 1.17 | mm | Nylon resists the |
| | | | | gas/fluid |
| Hydrofill/PET | EVOH | 1.185 | ˜25 mm | EVOH resists the |
| | | | | gas/fluid |
| COPET/PET | Hydrofil | 1.246 | ˜22 mm | Hydrofil resists the |
| | | | | gas/fluid |
| COPET/PET | PBT | 1.26 | ˜20 mm | PBT resists the |
| | | | | gas/fluid |
| COPET/PET | Copet* | 1.17 | ˜50 mm | Copet resists the |
| | | | | gas/fluid |

[****] The various abbreviations used in Table I are as follows:
COPET: Polyethylene terephthalate copolymer, Dupont ® Crystar 4446
PET: Polyethylene terephthalate, Dupont ® Crystar 4441
Hydrofil: Hydrophilic Nylon 6, Honeywell ® Capron SJES
Nylon: Nylon 6, BASF ® Nylon B4
PBT: Polybutylene terephthalate, Ticona ® Celanex 2000-3
Copet*, Polyethylene terephthalate copolymer, Eastman ® Eastar GN 071
EVOH, Ethylene Vinyl Alcohol copolymer, EVALAC ® F104B
PP. Polypropylene Pinnacle Polymers PP1630

The data in Table I indicate that the uncoated wicking devices 100 result in excessive flame heights or deterioration of the wicking device 100. The shell material 120 coated wicking devices 100, however, provided consistent flame heights and the wicking devices 100 were stable in the gas and/or liquid material. Wicking devices 100 with higher densities effectively restricted the flow of gas and/or liquid in the tests

Additional examples of wicking devices 100 formed according to embodiments of the present invention follow:

### EXAMPLE 1

A wicking device or regulator was made which included a bonded fiber element constructed of a core polymer of polyethylene terephthalate and a sheath polymer of polyethylene terephthalate copolymer. The core polymer was formed from DuPont Crystar 4441 polyester while the sheath polymer was formed from DuPont Crystar 4446. The sheath polymer accounted for about 30 percent by weight of the bonded fiber element and the core polymer accounted for about 70 percent by weight. The fibers were spun by a conventional bicomponent melt spinning machine using Hill's etched plate bicomponent fiber spinning technology. The spun fibers were drawn into filaments with denier per filament around 2 at the draw ratio of approximately 3:1. The drawn fibers were then heated to 230° C. and bonded in a heated forming die to a net shaped bonded fiber rod. The bonded fiber rod was then coated with an extruded shell material using a conventional Davis Standard extruder attached to an extrusion die with a uniform coating of Eastman Eastar GN 071 copolyester. The resultant wicking device had a porosity of 0.13. When inserted into a lighter body with butane, the subsequent height of the flame produced from butane conducted through the wicking device was 50 mm.

### EXAMPLE 2

A wicking device or regulator was made which included a bonded fiber element constructed as in example 1 above. The bonded fiber rod was then coated with an extruded shell material using a conventional Davis Standard extruder attached to an extrusion die with a uniform coating of polybutylene terephthalate, Ticona Celanex 2000-3. The resultant wicking device had a porosity of 0.08. When inserted into a lighter body with butane, the subsequent height of the flame produced from butane conducted through the wicking device was 25 mm.

### EXAMPLE 3

A wicking device or regulator was made which included a bonded fiber element constructed of a core polymer of polyethylene terephthalate and a sheath polymer of polyethylene terephthalate copolymer. The core polymer was formed from DuPont Crystar 4441 polyester while the sheath polymer was formed from Honeywell Capron SJES nylon copolymer. The sheath polymer accounted for about 40 percent by weight of the fibers in the bonded fiber element and the core polymer accounted for about 60 percent by weight. The fibers were spun by a conventional bicomponent melt spinning machine using Hill's etched plate bicomponent fiber spinning technology. The spun fibers were drawn into filaments with denier per filament around 3 at the draw ratio of approximately 3:1. The drawn fibers were then heated to 230° C. and bonded in a heated forming die to a net shaped bonded fiber rod. The bonded fiber rod was then coated with an extruded shell material using a conventional Davis Standard extruder attached to an extrusion die with a uniform coating of Evalco F104B ethylene vinyl alcohol resin. The resultant wicking device had a porosity of 0.11. When inserted into a lighter body with butane, the subsequent height of the flame produced from butane conducted through the wicking device was 22 mm.

### EXAMPLE 4

A wicking device or regulator was made which included a bonded fiber element constructed as in example 1 above. The bonded fiber rod was then coated with an extruded shell material using a conventional Davis Standard extruder attached to an extrusion die with a uniform coating of Honeywell Capron SJES nylon copolymer. The resultant wicking device had a porosity of 0.08. When inserted into a lighter body with butane, the subsequent height of the flame produced from butane conducted through the wicking device was 25 mm.

Having thus described certain embodiments of the present invention, it is to be understood that the invention defined by the appended claims is not to be limited by particular details set forth in the above description as many apparent variations thereof are possible without departing from the spirit or scope thereof as hereinafter claimed.

What is claimed is:

1. A wicking device, comprising:
a core material providing a tortuous path for gas or liquid flow; and
a polymeric shell material surrounding at least a portion of said core material.

2. The wicking device of claim 1, wherein said core material comprises a polymeric material.

3. The wicking device of claim 1, wherein said core material comprises a bonded fiber element.

4. The wicking device of claim 3, wherein said bonded fiber element comprises:
at least one core polymer fiber; and
a sheath polymer covering said at least one core polymer.

5. The wicking device of claim 3, wherein said bonded fiber element comprises a plurality of bonded multi-component fibers.

6. The wicking device of claim 3, wherein said bonded fiber element comprises a plurality of multi-component fibers that are partially bonded together to provide voids within said bonded fiber element.

7. The wicking device of claim 3, wherein said bonded fiber element comprises a plurality of fibers having a core polymer surrounded by sheath polymers, the sheath polymers of said plurality of fibers being partially bonded to provide voids within said bonded fiber element, said voids providing said tortuous path for gas or liquid flow through said core material.

8. The wicking device of claim 1, wherein said core material is selected from the group consisting of polyolefins, polyseters, polyamides, flouropolymers, polyarylates, polycarbonates, polyvinyl chloride, polystyrene, ABS, acetal homopolymers and copolymers, polyacrylonitrile, polymethylmethacrylate, polyvinyl alcohol, polyethyleneglycol, and ethylene vinyl alcohol copolymers.

9. The wicking device of claim 1, wherein said shell material is selected from the group consisting of polyolefins, polyseters, polyamides, flouropolymers, polyarylates, polycarbonates, polyvinyl chloride, polystyrene, ABS, acetal homopolymers and copolymers, polyacrylonitrile, polymethylmethacrylate, polyvinyl alcohol, polyethyleneglycol, and ethylene vinyl alcohol copolymers.

10. The wicking device of claim 1, wherein said core material is permeable to hydrocarbon gas, hydrocarbon liquid, or mixtures of hydrocarbon gas and liquid.

11. The wicking device of claim 1, wherein said core material is chemically resistant to hydrocarbons.

12. The wicking device of claim 1, wherein said shell material is impermeable to liquid.

13. The wicking device of claim 1, wherein said shell material is impermeable to gas.

14. The wicking device of claim 1, wherein said shell material is chemically resistant to hydrocarbons.

15. A wicking device, comprising:
a porous bonded fiber element for providing a tortuous flow of a gas or liquid; and
a shell material surrounding at least a portion of the porous bonded fiber element, wherein said shell material is impermeable to said gas and said liquid.

16. The wicking device of claim 15, wherein said porous bonded fiber element comprises polymeric multi-component fibers formed from polymers selected from the group consisting of polyolefins, polyseters, polyamides, flouropolymers, polyarylates, polycarbonates, polyvinyl chloride, polystyrene, ABS, acetal homopolymers and copolymers, polyacrylonitrile, polymethylmethacrylate, polyvinyl alcohol, polyethyleneglycol, and ethylene vinyl alcohol copolymers.

17. The wicking device of claim 15, wherein said shell material comprises a polymer selected from the group consisting of polyolefins, polyseters, polyamides, flouropolymers, polyarylates, polycarbonates, polyvinyl chloride, polystyrene, ABS, acetal homopolymers and copolymers, polyacrylonitrile, polymethylmethacrylate, polyvinyl alcohol, polyethyleneglycol, and ethylene vinyl alcohol copolymers.

18. The wicking device of claim 15, wherein said shell material comprises a polymeric extruded wrapping around said core material.

19. The wicking device of claim 15, wherein said wicking device is attached to a valve in a lighter.

20. A method for regulating the flow of a gas or a liquid, comprising:
providing a liquid source;
contacting said liquid source with a wicking device, wherein the wicking device comprises a core material surrounded by a shell material, said core material providing a tortuous path for gas or liquid flow; and
flowing liquid from said liquid source through said wicking device.
